(19) United States
(12) Patent Application Publication
(10) Pub. No.: US 2001/0034732 A1
(43) Pub. Date: Oct. 25, 2001

(54) Architecture and method for deploying remote database administration

(76) Inventors: Mark Vorholt, Cincinnati, OH (US); Dean Mitchell, Cincinnati, OH (US); Bryan Bourne, Liberty Township, OH (US)

Correspondence Address: SKINNER & ASSOCIATES, 619 SECOND STREET, SUITE 201, HUDSON, WI, 54016, US

(21) Appl. No.: 09/788,785

(22) Filed: Feb. 20, 2001

Related U.S. Application Data
(60) Provisional application No. 60/183,202, filed on Feb. 17, 2000.

(51) Int. Cl. G06F 17/30

(52) U.S. Cl. 707/10; 707/200

(57) ABSTRACT

Disclosed is a computing architecture and method for remotely managing key aspects of relational database management systems. The architecture and method makes use of internet connectivity, a database of historical performance data, a reporting system and a centralized database operations center. These components, in conjunction with software from BMC Inc., allow for the delivery of integrated database administration activities to remote processing sites from a central location.

### CROSS-REFERENCE TO RELATED APPLICATIONS, IF ANY

This application claims the benefit under 35 U.S.C. §119(e) of co-pending provisional application Ser. No. 60/183,202, filed Feb. 17, 2000, which is hereby incorporated by reference.

### 37 C.F.R. §1.71(e) AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to database management systems. More particularly, the invention relates to an architecture and method for deploying remote database administration. Specifically, the invention relates to a holistic approach to remotely manage relational database management systems.

2. Background Information

The state of the art includes various methods and devices for administering databases. These known methods and devices are believed to have significant limitations and shortcomings.

Database management systems require ongoing administration to maintain the overall availability and performance of the database. This administration is highly specialized and personnel competent in the area are typically referred to as Database Administrators.

Existing methods for the technical administration of database management systems have traditionally relied upon Database Administrator personnel to be resident at a local place of work in order to have access to the tools and systems required to perform such work.

Additionally, the development of reporting subsystems to accurately reflect the database performance and trending characteristics involved a good deal of time and effort. Another limitation of the current art is the scarce resource of the skills available to perform this type of work resulting in a constant turnover in this position for the employer.

The present invention provides an architecture and method for deploying remote database administration which is believed to constitute an improvement over the known art. The present invention overcomes the problems associated with the known art by enabling personnel to perform the required technical tasks associated with managing the database system from a remote location. Additionally the invention provides, through the means of propriety software and a specialized database structure, a consistent set of reports that can be used to ascertain the current and future performance of the database system.

### BRIEF SUMMARY OF THE INVENTION

The present invention provides an architecture for remote database management, which generally comprises at least one remotely-located host database server, first communication means adapted for providing a link to monitor remote database servers, second communication means adapted for providing a link to enable corrective actions on the remote database servers, and a database operations center where the remotely-located host database servers are monitored. A BMC Patrol™ agent software program, supplied by BMC Software, Inc. of Houston, Tex., USA, operates in each remotely-located host database server. The database administrator may view the remotely-located host database servers using a set of BMC Patrol™ Consoles in the database operations center. The architecture may further comprise a help desk application adapted for recording logged event activity, a historical database server adapted for storing performance metrics, and a reporting feature adapted for generating customized performance reports for each said remotely-located host database.

The present invention provides the capability of performing database administration tasks from a remote location for a wide variety of relational database systems, automates the reporting of key performance trend information by utilizing a relational database data store and reporting processes, and provides for automated paging notification of remote support personnel without human intervention. Other advantages of the method and architecture of the invention include an ongoing automated threshold monitoring of the database system, a technical assessment of the database environment by experienced database administrators, and the logging of events to a central Database Operations Center (hereinafter referred to as “DBOC”).

The features, benefits and objects of this invention will become clear to those skilled in the art by reference to the following description, claims and drawings.

### BRIEF DESCRIPTION OF THE SEVERAL VIEWS OF THE DRAWING

FIG. 1 is a high level architecture diagram of a prefered embodiment of the remote database administration system of the present invention, depicting the components of the system, their relationships, and their location for supporting the remote administration environment.

FIG. 2 illustrates a PATROL Console™ showing the status of parameters monitored by the system for Unix and drill down to access detailed information, menu commands and reports.

FIG. 3 illustrates a PATROL Console for MS SQL Server monitoring all aspects of the SQL Server environment from the server level to specific tables and indexes.

FIG. 4 illustrates PATROL Alarm Manager working with PATROL application service management software.

FIG. 5 is a diagram of an AM Check Events process.

FIGS. 6-12 illustrate exemplary reports generated by the system and method of the present invention.

### DETAILED DESCRIPTION

The system and method of the present invention provide remote support via dial-up and the INTERNET global communication network to perform database administrator tasks required by owners of databases utilizing various database systems such as Oracle®, Sybase™, Informix™, or Microsoft® SQL Server™. Available capabilities utilizing the invention include monitoring, tuning and preventative maintenance functions. The system and method are useable for a single database server or an entire enterprise system of servers.

The benefits of the system and method of the present invention include:

user obtains ongoing production support for database servers

user can selectively outsource entire projects, including purchased solutions, departmental applications, and the like

user can obtain mentoring of less experienced on site Database Administrators

experienced Database Administrators may be made selectively available to a user on only an “as needed” basis

user has the ability to assign costs of Database Administrator work to a specific project for user budgetary purposes

user obtains regular reports of database activity, growth and planning advise

### 1. System Overview

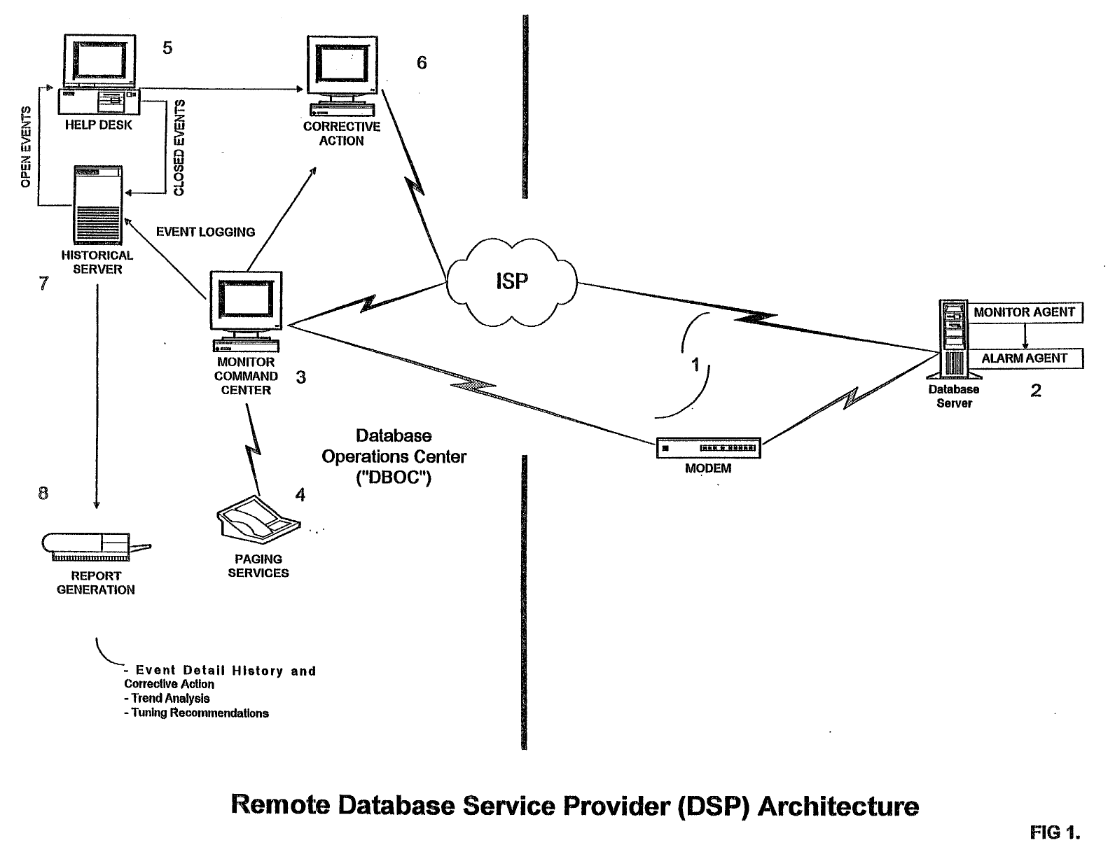

Referring to FIG. 1, an example of the preferred architecture embodiment of the present invention is illustrated. The first component 1 of the architecture is the connectivity provided through both the internet and modem dial-up access. This access is provided through the client's firewall via a UDP port that is directed to the database server being monitored.

The client database server or servers 2 has BMC® Patrol™ application service management software and a combination of PATROL Knowledge Module software installed depending on the database and operating system platform. Additionally, PATROL Alarm Manager™ software is installed on all servers. These software systems, as well as certain other software systems identified below, are supplied by BMC Software, Inc. of Houston, Tex., USA. These are initiated at the client server and collect performance and other data.

Performance and other data are reported to the Database Operations Center (“DBOC”) and displayed on one or more consoles 3. The consoles have the PATROL Developer Console installed. The console information is reviewed by experienced command center personnel who have specific expertise in the various databases and whose efforts may further be pooled by virtue of being located in a single command center location to enable faster, improved and continuous database management service. If there are exceptions or error conditions the assigned Database Administrator is notified.

Communication between the client database server 2 and the DBOC is made via direct telephone line dial-up and the Internet global communications network. The client database server 2 preferably has Internet Email communication capability also.

### 2. Client's Remote Database Server

Referring to FIG. 1, an example of the preferred embodiment of the system for remote database administration of the present invention is illustrated. The first component 1 of the architecture is the connectivity provided through both the internet and modem dial-up access. This access is provided preferably through the client's firewall via a UDP port that is directed to the database server being monitored.

The client database server or servers 2 has operative BMC( Patrol™ application service management software. This software is generally used for automated administration, monitoring, and management of various components of a distributed enterprise. PATROL software supports a wide array of operating systems, and applications, including databases, middle ware, Internet applications and the underlying technology thereof. With respect to databases, PATROL service management software permits management of multiple databases from a central console providing a view of the enterprise. PATROL application service management software enables comprehensive integration with various third-party management solutions.

In addition to the PATROL application service management software, a combination of one or more knowledge module software may be installed on the client database server 2, depending on the particular database and operating system platform of the client. Knowledge modules are specific to the applications of the environment and contain application-specific intelligence, reporting parameters and management options. PATROL application service management software permits administrators to monitor and manage all PATROL knowledge modules within the environments from one or multiple consoles. Exemplary PATROL knowledge modules consistent with the present invention include:

PATROL Knowledge Module for Oracle™

PATROL Knowledge Module for SQL Server™

PATROL Knowledge Module for Sybase™

PATROL Knowledge Module for Informix™

PATROL Knowledge Module for UDB™

PATROL Knowledge Module for Unix™

PATROL Knowledge Module for NT™

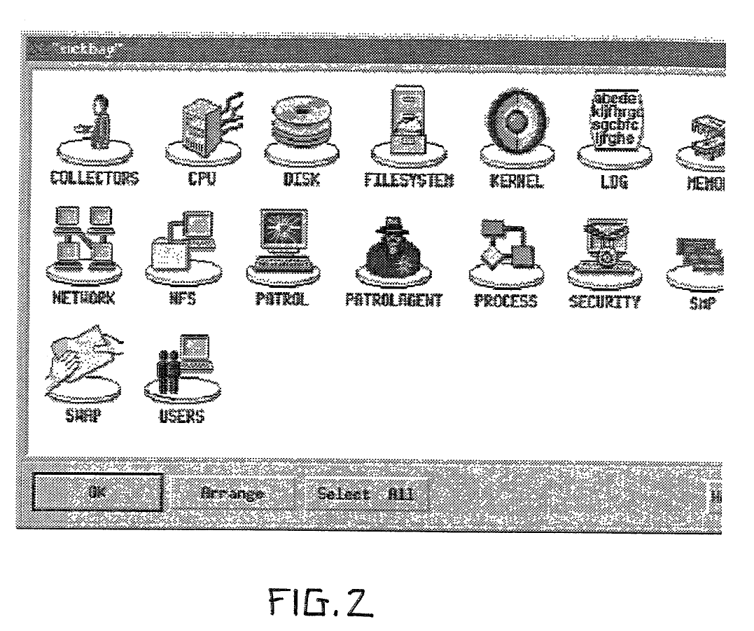

Referring to the PATROL KM for Unix KM as an example, the module forms a dynamic library of critical information used to centrally monitor and manage various Unix operating systems, including delivering automated resource monitoring and management functions, executing proactive and automated corrective actions to solve problems and potential problems, obtains monitoring information from both OS and kernel levels, allows execution of Unix commands through menu items, provides information through console view, infoboxes, reports, graphs, charts and gauges. Referring to FIG. 2, it provides current and historical information through a centralized location so that the user can easily see the status of the OS environment. Detailed parameter data is viewable, including storage capacity, available space, number of unused i-nodes, and percentage of i-nodes in use. In addition to monitoring parameters, it can proactively take corrective actions when things go wrong.

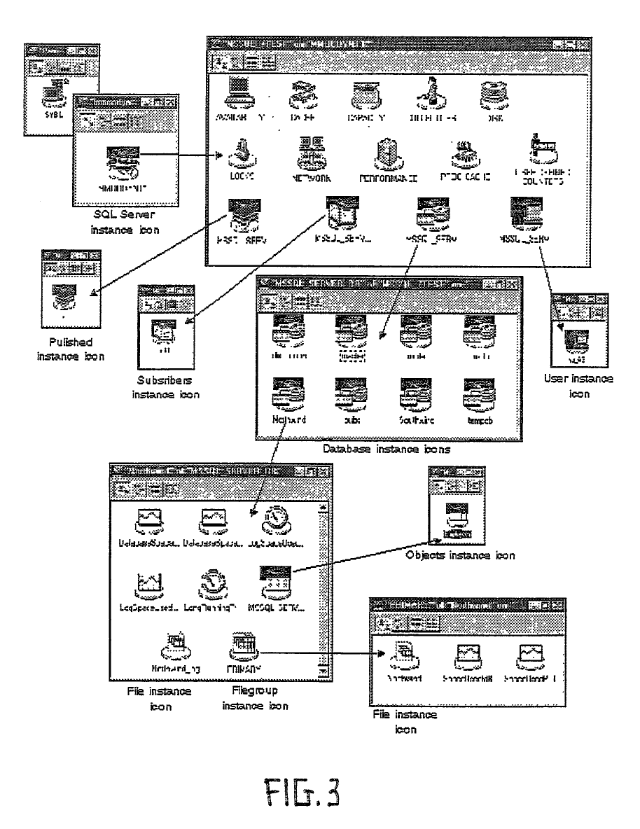

PATROL KM for Microsoft SQL Server has similar functionality to that disclosed above with respect to Unix OS. FIG. 3 shows the status of aspects of the SQL Server environment from the server level to specific tables and indexes.

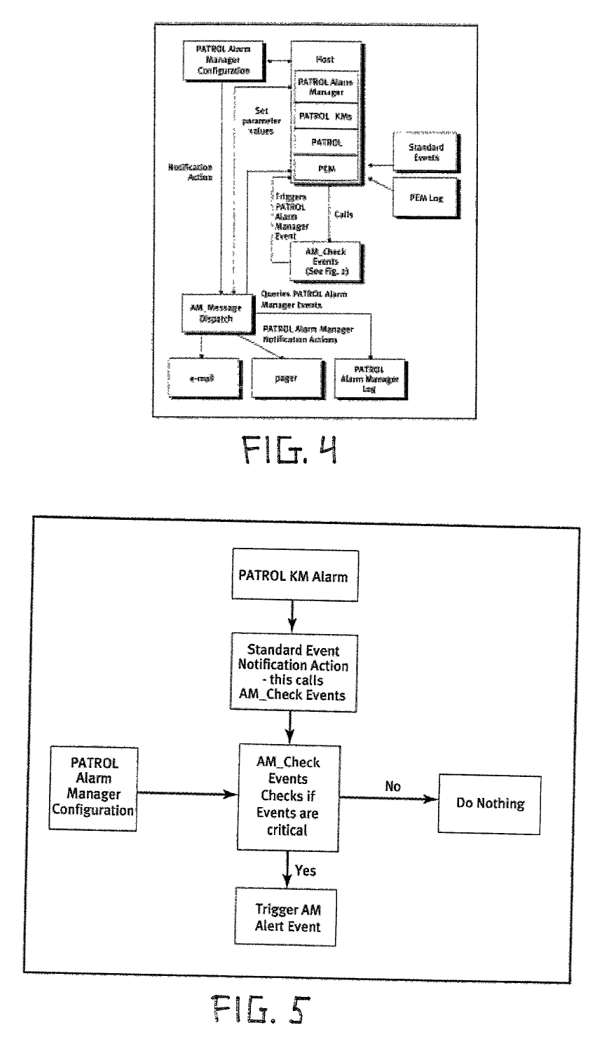

Additionally, PATROL Alarm Manager™ software is installed on all servers. PATROL Alarm Manager provides alarm management and notification for all Unix or Windows NT systems monitored by PATROL application service management software, and also works on other platforms that the application supports. Referring to FIG. 4, in general, it provides critical event notification for systems monitored by PATROL application service management software, provides extended notification of warnings and alarms to customer's third-party paging/messaging systems, has complete shift support and blackout capabilities, and easily defines and administers critical system parameters. Alarm manager integrates with other Patrol software to provide an easy to use Graphical User Interface (“GUI”) for administrators to designate critical parameters for paging. It extends notification and alarms to the customers' paging/messaging systems to keep administrators and operators informed of critical areas so that problems can be solved before they impact the system.

Referring also to FIG. 5, Patrol Alarm Manager consists of the following components:

AM Setup: Allows user to configure the product, including the Alarm Management Policy (“AMP”) notification methods and critical time periods.

AM Host: Displays hosts that are to be monitored and managed by the Patrol Alarm Manager; creates and icon for each host.

AM Policy: Displays a list of all application classes that represent the AMP, contains parameters for the number of critical alarms sent/received for that application class; and reports on critical business parameters.

AM Message Dispatch: Is responsible for event notifications and execution of critical business events.

Alarm Manager is easy to configure and allow the user to define parameters to be used by the host as well as the method and recipient of alarm notifications. Once these options have been configured, the user can send AMP configurations to all of the monitored hosts. Configure options are easy to modify later if needs change. Steps include:

Define Alarm Manager setting, including alarm approach, message levels and user levels, so the user can control how the product operates.

Define the agents in a workgroup, including the name of the host system to be monitored, the port number the agent is running on, the username and the password.

Define message centers, to determine which agents (one or many) will act as the message centers.

Define the enterprise AMP configuration to specify which critical applications or parameters to monitor at the enterprise level

Define the global time settings or time periods when alarm and warning notification should be sent to the message center (for example, monitoring the host systems 12 hours, seven days a wee; or 10 hours per day on weekends, etc.).

Configure roles for users to which notifications will be sent, for example, if the “Oracle Database Administrator” is defined, and the Oracle database goes into alarm, a page or email will be sent to that particular database administrator; roles can be changed, deleted or viewed with no changes.

Configure the notification actions to define the type of commands used in notification or alarms and warnings; these can be changed, deleted or viewed.

Apply the AMP to all hosts in the workgroup, once it is configured;

Define the local AMP if a local host has a different policy from that of the enterprise policy (for example, if one needs one host to be monitored during a different time than all of the other host systems).

Parameters are used to determine the defined thresholds for alarm notification. Alarm manager contains parameters that indicate the number of critical alarms that have occurred for defined AMPs. Patrol KMs on the system contain parameter that monitor the applications or databases. Alarm Manager enables operators to define those parameters in Patrol KMs that are considered critical (for example Oracle Free Space). These critical parameters determine the policy. Internal monitored parameters for the Alarm Manager include:

Message Dispatch: event notification on/off.

NumEvents Receive: the number of events received for a given host.

NumEventsSent: the number of events sent for a particular host.

Remote AgentAlive: determines whether the agent is running or not.

NumEventsClass: determines the number of times the class and the parameters in it have gone into alarm.

NumEventsParameter: determines the number of times the total parameters have gone into alarm.

Patrol Alarm Manager helps administrators ensure availability of critical applications by providing the following benefits:

Controlled notification of critical events. Users define critical parameter, applications or instances to e monitored and critical thresholds that can trigger notification.

Integration to third party messaging systems. When critical thresholds are crossed, user defined notification actions are executed and the responsible parties are notified by page, email or another third party device.

A GUI for easily setting enterprise AMP, which means the user can define parameters, instances and applications, as well as when to alert and who will be alerted of alarms when they occur for each agent.

A choice of two configurations for managing alarms. A centralized approach allows one or more agents to act as a message center over the other agents, and provides one point of control and management. Also, only one server then needs either a modem or access to the Internet. A distributed approach allow agents to act separately, providing local control over message notification for specific workgroups or departments.

Support for escalation procedures, by shift or by week.

The software installed on the client servers operates as an autonomous agent. These agents do not require communication from a console in order to operate. They are initiated at the client server and collect data independent of available communication.

The PATROL software is configured to identify key performance metrics. These metrics can very somewhat for each client, however, the following metrics are always included:

Database freespace

Server Availability

Maximum Space Extents

Percent CPU Busy

Buffer Hit Ratio

Memory Consumption

User Status

Processes in Use

Lock Requests

Log Growth

The client database server 2 also will likely have backup software. Such backup software can be monitored and utilized by the system of the present invention.

### 3. DBOC

Summarized performance data and exceptions to the thresholds are reported back to the Database Operations Center (“DBOC”) and displayed on the Consoles 3. These consoles have the PATROL Developer Console installed. PATROL Knowledge Module software summarizes the performance data, and the PATROL Developer Console accumulates this summarized data. The console information is reviewed by the command center personnel. If there are exceptions or error conditions the assigned database administrator is notified. The Database Administrator can use the console to gather additional information about the alert that was generated.

For unattended operations, an alarm agent resides on the client server 2. The alarm agent has the capability to send pages 4 to the Database Administrator support staff. These pages can carry alphanumeric messages indicating the exact nature of the problem encountered.

All activity associated with the database server being monitored is captured in a help desk system 5, preferably utilizing Microsoft Outlook™. This information is used to keep a detailed record of the problems that are open on the account and to provide client feedback regarding work performed on the server.

If corrective action needs to occur, the Database Administrator logs into the server via a secure console 6 and takes the required action.

In addition to the agents that monitor the database server status, historical data is also captured locally at the server 2. This historical data represents values of the metrics that are taken on a periodic basis and stored on a local disk device. On a periodic basis this data is transferred to a historical data server 7 located at the DBOC, preferably via FTP. This server functions as a composite data store for all the managed servers and contains the historical metric information. Microsoft SQL Server™ is implemented on the server using a customized database design. This database is designed to hold the performance metric data for each account in both a detail and a summary level. Appendix A shows a table, index and view definitions for a PATROL History target database.

This database is also used to generate reports 8 describing both the current state of the performance on the monitored servers and the trends of the resource usage on the server by retrieving and manipulating data from the historical server. These customized reports include the following:

CPU Utilization and Trends

Buffer Hit Ratio and Trends

Response Time Trends

User Call Rates

Disk Transfers Per Second

Free Memory

Log Addition Rates

Tablespace Space Usage

File System Growth

Log File Space Growth

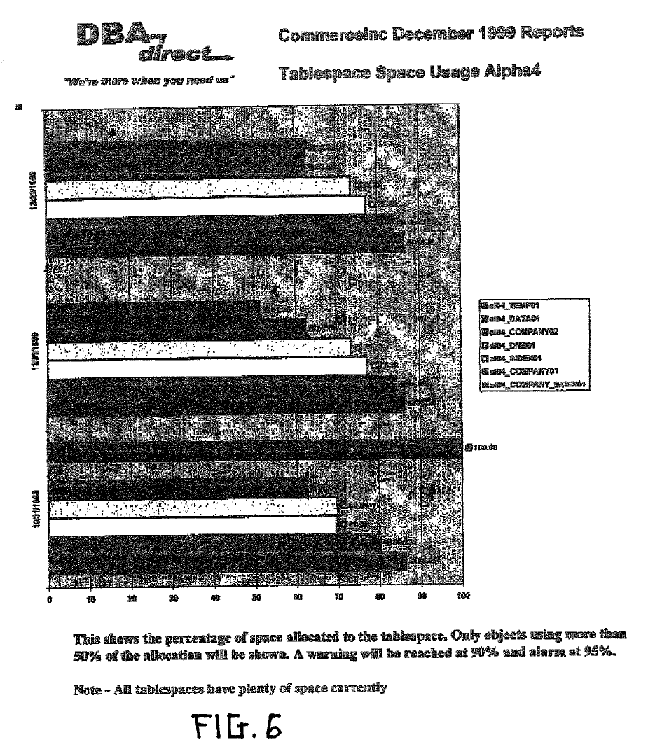

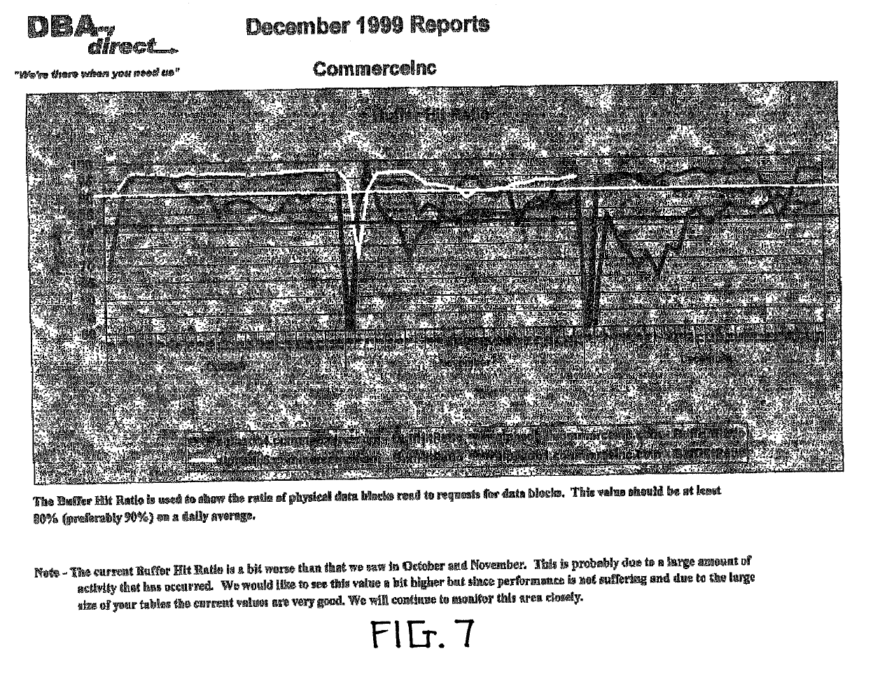

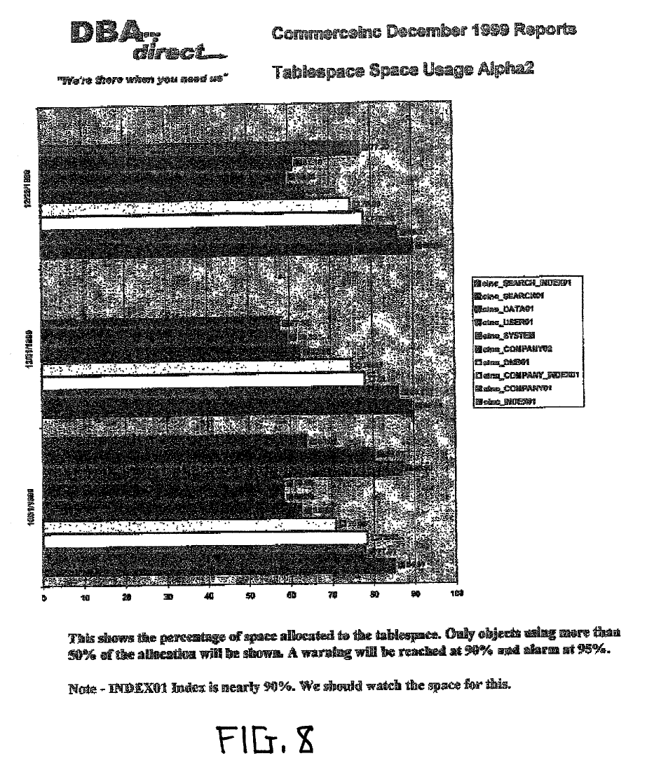

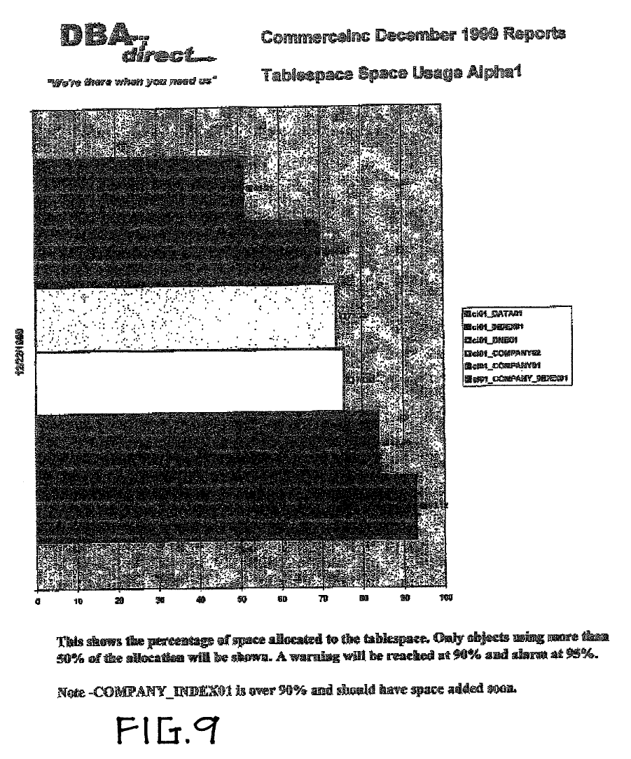

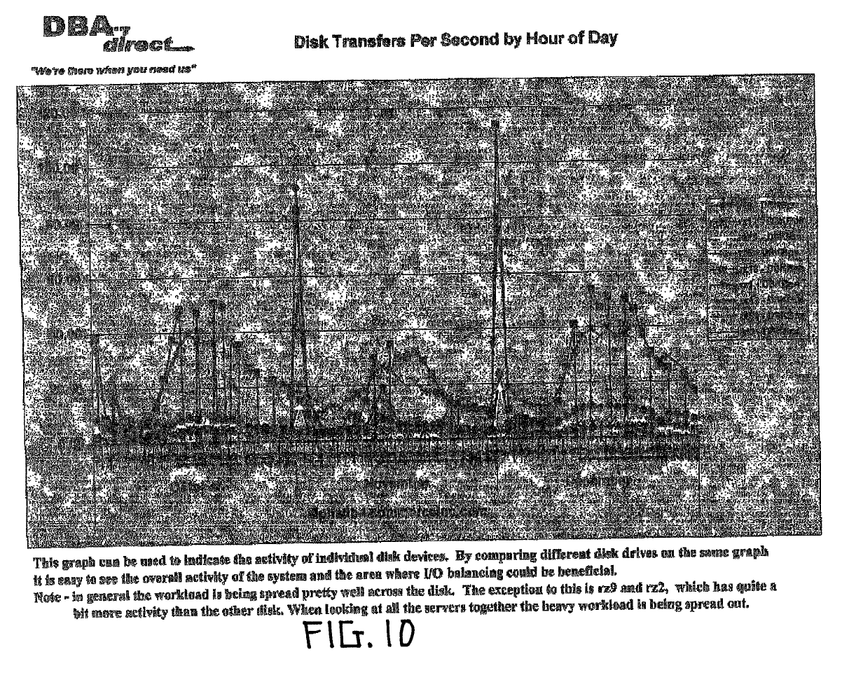

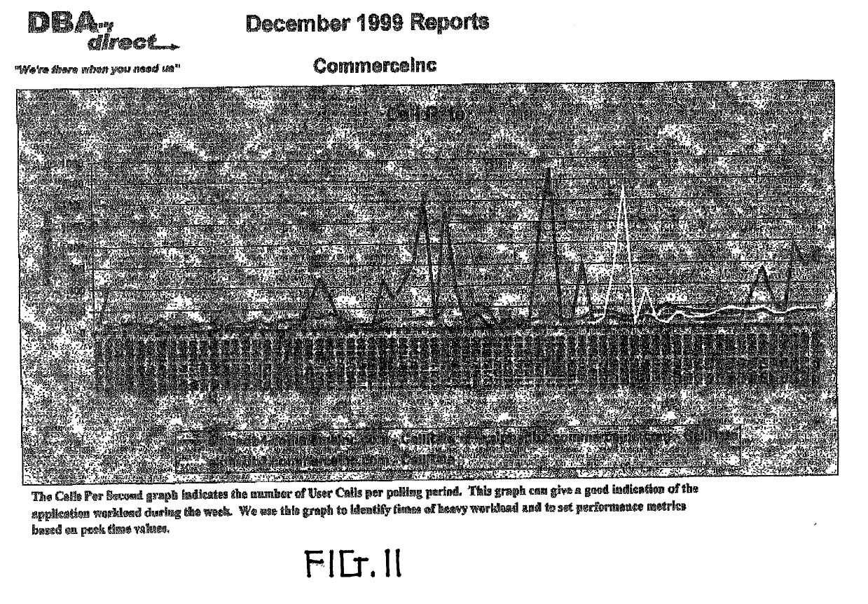

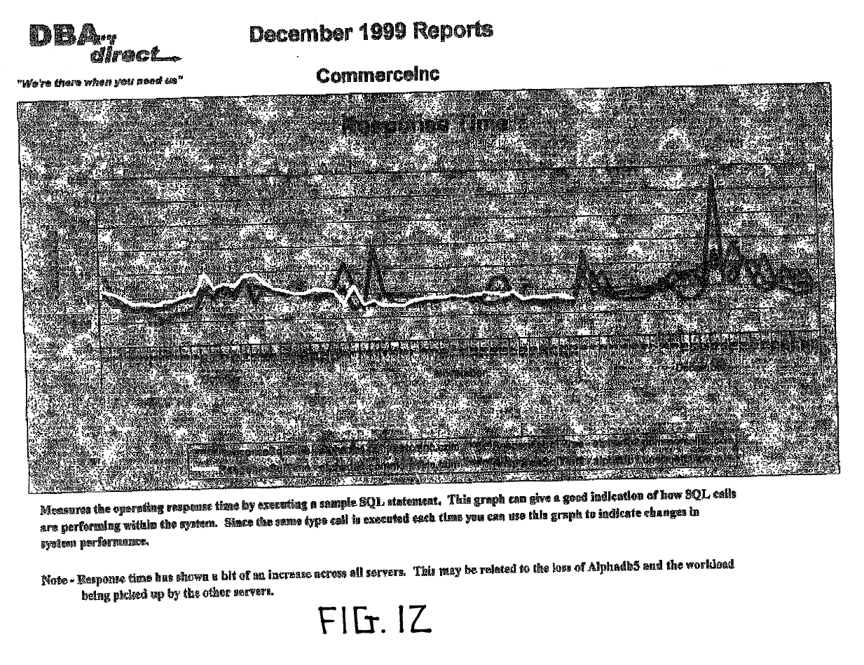

FIGS. 6-12 illustrate example reports generated by the system and method of the present invention.

### 4. Methods and Processes

The remote database administration system of the present invention is implemented by first gathering information concerning the support needs of the database servers being considered for remote administration, including information about the complexity of the database environment and factors which are important to the successful functioning the database. Secondly, direct dialup and Internet connectivity is established between the DBOC and the remote database server. Thirdly, software is installed at the remote server, configured at the remote server and the DBOC, and tested. Finally, remote database administration is implemented including monitoring, preventative maintenance, and corrective maintenance.

In general, administration involves problem determination, root cause analysis, corrective action, and performance tuning for all database related issues. Specific support activities include space management to ensure that the amount of disk space required is available. Administration provides early warning of potential space issues. Backup/recovery verification involves checking that backups have been performed and that they are viable input into the recover procedures. Performance tuning involves analyzing index usage, tuning indexes to maximize index usage, and creating, dropping or altering indexes as required for performance improvement. Database fragmentation involves monitoring internal database space for fragmentation and scheduling database reorganizations to correct excessive fragmentation. Fragmentation can lead to excessive page chaining, which leads to poor performance. Monitoring of key resources involves recording resource shortages in the area of CPU and memory, and making recommendations regarding the need for additional hardware or software resources. Database warning analysis involves using automated processes to constantly check error log file for warnings or errors reported by the database management system and then taking appropriate measures to resolve the root cause of any such warnings or errors. Statistical updates involves determining the timing of updating internal database statistics to improve optimizer performance. Database integrity checks involves periodic execution of DBCC utilities to verify structure integrity of database schema an taking corrective actions if required. Finally, trend analysis involves providing reports regarding performance and resource trends, whereby the database environment can be managed proactively.

Examples of client situations covered by use of the system and process of the present invention include:

Client acquires new application that requires for example MS SQL Server

After application vendor installs application, the remote database administration process will monitor and tune the application environment, respond to down situations, and ensure backup and recovery capability. Additionally, the database administrator personnel at the DBOC can work directly with the application vendor to resolve any issues that they cannot resolve independently themselves.

Client's database administrator(s) is overworked due to problem solving or new project development

Remote Database Administration process is used to “back up” client's database administrator so that preventative actions can be taken in addition to problem solving, and so that production environment is maintained on call in addition to new project development.

Client's database administrator(s) is competent in existing database platforms, but not yet competent in new, atypical, platform shortly to be put into production Remote Database Administration process is used to support atypical platform to obviate the need to train client staff for the non-standard platform or to add to the existing on-call support burden. Thus, utilizing the invention, a database server that is not part of the typical or standard architecture (but which is otherwise beneficial to the client) is supportable without additional strain on the client's existing database administrator staff.

### 5. Conclusion

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

APPENDIX A

| | |
|---|---|
| -- FILE | : dbadirect.sql |
| -- DATE | : 02/16/2000 08:37:26 AM |
| -- DATASOURCE | : dbadirect (SQL Server) |
| -- VERSION | : 7.00.699 |
| -- TARGET DB | : Patrol_History |
| -- | |

-- Target Database: Patrol_History
--

Table Definitions

CREATE TABLE dbo.p_apps
(

| | | |
|---|---|---|
| app_id | int | NULL, |
| node_name | varchar(32) | NOT NULL, |
| app_name | varchar(32) | NOT NULL, |
| parameter_name | varchar(32) | NULL |

)
CREATE TABLE dbo.p_history
(

| | | |
|---|---|---|
| history_id | int | NULL, |
| app_id | int | NOT NULL, |
| instance_id | int | NOT NULL, |
| timestamp | datetime | NOT NULL, |
| value | float | NULL |

)
CREATE TABLE dbo.p_hold_data
(

| | | |
|---|---|---|
| app_id | int | NULL, |
| instance_id | int | NULL, |
| tmp_node_name | varchar(32) | NULL, |
| tmp_app_name | varchar(32) | NULL, |
| tmp_instance_name | varchar(32) | NULL, |
| tmp_parameter_name | varchar(32) | NULL, |
| tmp_time_stamp | datetime | NULL, |
| tmp_value | float | NULL |

)
CREATE TABLE dbo.p_instances
(

| | | |
|---|---|---|
| instance_id | int | NULL, |
| instance_name | varchar(32) | NOT NULL |

)
CREATE TABLE dbo.p_tmp_history_data
(

| | | |
|---|---|---|
| app_id | int | NULL, |
| instance_id | int | NULL, |
| tmp_node_name | varchar(32) | NULL, |
| tmp_app_name | varchar(32) | NULL, |
| tmp_instance_name | varchar(32) | NULL, |
| tmp_parameter_name | varchar(32) | NULL, |
| tmp_time_stamp | varchar(32) | NULL, |
| tmp_value | varchar(255) | NULL |

)

Index Definitions

| | |
|---|---|
| CREATE | CLUSTERED INDEX XPKApps |
| ON | dbo.p_apps (app_id) |
| CREATE | CLUSTERED INDEX XPKHistory |
| ON | dbo.p_history (app_id, instance_id, timestamp,value) |
| CREATE | CLUSTERED INDEX XPKInstance |
| ON | dbo.p_instances (instance_id) |
| CREATE | UNIQUE NONCLUSTERED INDEX XPKNApps |
| ON | dbo.p_apps(node_name,app_name,parameter_name) |
| WITH | IGNORE_DUP_KEY |
| CREATE | UNIQUE NONCLUSTERED INDEX XPKNInstance |
| ON | dbo.p_instances (instance_name) |
| WITH | IGNORE_DUP_KEY |

View Definitions

CREATE VIEW p_view (

node_name,
app_name,
instance_name,
parameter_name,
time_stamp,
value)

AS

| | |
|---|---|
| select | pa.node_name, |
| | pa.app_name, |
| | pi.instance_name, |
| | pa.parameter_name, |
| | ph.timestamp, |
| | ph.value |
| from | p_apps pa, |
| | p_instances pi, |
| | p_history ph |
| where | pa.app_id = ph.app_id |
| and | pi.instance_id = ph.instance_id |

CREATE VIEW dbo.p_avg_hour
AS

| | |
|---|---|
| select | node name, |
| | app_name, |
| | instance_name, |
| | parameter_name, |
| | ′Year′=datepart(year, time_stamp), |
| | ′Month′=datename(month, time_stamp), |
| | ′MonthNo′=datepart(month, time_stamp), |
| | ′Hour′=datepart(hour, time stamp), ′value′=avg(value) |
| from | dbo.p_view |
| group by | node_name, |
| | app_name, |
| | instance_name, |
| | parameter_name, |
| | datepart(year, time_stamp), |
| | datepart(month, time_stamp) |
| | datename(month, time_stamp), datepart(hour, time_stamp) |

CREATE VIEW dbo.p_view_day
AS

| | |
|---|---|
| select | node_name, |
| | app_name, |
| | instance_name, |
| | parameter_name, |
| | ′sort_date′=convert(char(10), time_stamp, 102), |
| | ′Date′=convert(char(10), time_stamp, 101), |
| | ′value′=avg(value) |
| from | dbo.p_view |
| group by | node_name, |
| | app_name, |
| | instance_name, |
| | parameter_name, |
| | convert(char(10), time_stamp, 102), |
| | convert(char(10),time_stamp, 101) |

CREATE VIEW dbo.p_view_hour
AS

| | |
|---|---|
| select | node_name, |
| | app_name, |
| | instance_name, |
| | parameter_name, |
| | ′Date′=convert(char(10), time_stamp, 101) , |
| | ′hour′=datepart(hour, time_stamp), |
| | ′value′=avg(value) |
| from | dbo.p_view |
| group by | node_name, |
| | app_name, |
| | instance_name, |
| | parameter_name, |
| | convert(char(10), time_stamp, 101), |
| | datepart(hour, time_stamp) |

The invention claimed is:

1. An architecture for remote database management, comprising:
(a) at least one host database server having agent software operating in each said remotely-located host database server;
(b) a first communication link adapted for providing a link to monitor said host database server;
(c) a second communication link adapted for providing a link to enable corrective actions to be made on said host database server; and
(d) a database operations center remotely located from said host database server, said database operations center being connected to said first and second communication link and having a set of consoles through which each said remotely-located host database server is monitored and controlled.

2. The architecture of claim 1, wherein said agent software is BMC PATROL application service management software.

3. The architecture of claim 1, wherein said set of consoles is provided by BMC PATROL console software.

4. The architecture of claim 1, further comprising a help desk application operatively disposed at said database operations center and being adapted for recording logged event activity for said host database server.

5. The architecture of claim 1, further comprising a historical database server disposed at said database operations center and bing adapted for storing performance metrics for said host database server.

6. The architecture of claim 1, further comprising a reporting system for generating performance reports for said host database server.

7. The architecture of claim 1, wherein said first communication link includes an Internet connection between said database operations center and said remotely-located host database server.

8. The architecture of claim 7, wherein said Internet global computer network connection made is across a firewall disposed at said host database server.

9. The architecture of claim 1, wherein said second communication link includes a modem connection through a telephone system with said remotely-located host database server.

10. A method for managing remotely-located database servers, comprising the steps of:
(a) collecting performance data at each remotely-located database server;
(b) transmitting said performance data from the remotely-located database server to a Database Operations Center;
(c) accumulating the performance data into a historical database; and
(d) generating reports from the accumulated performance data.

11. The method of claim 10, further comprising the step of summarizing performance data after collecting said performance data and prior to transmitting said performance data.

12. The method of claim 10, wherein said step of transmitting is accomplished utilizing the Internet global computer network.

13. The method for managing remotely-located database servers of claim 10, further comprising the step of repairing the remotely-located database over a secure communication link.

14. The method for managing remotely-located database servers of claim 10, further comprising the step of sending alert pages to one or more selected members of a Database Administrator support staff corresponding to at least one predetermined alert condition for said database server.

15. A computer system for maintaining historical performance of at least one remotely-located host database server, including a database residing in a memory of a computer, said database being adapted to store and manipulate the historical performance data captured by a software program operating on each said remotely-located host database server.
